(19) United States
(12) Patent Application Publication
(10) Pub. No.: US 2014/0300120 A1
(43) Pub. Date: Oct. 9, 2014

(54) SHOVEL DEVICE

(71) Applicants: Michael L. McEwen, Helena, MT (US); Dan Stefanik, Helena, MT (US)

(72) Inventors: Michael L. McEwen, Helena, MT (US); Dan Stefanik, Helena, MT (US)

(21) Appl. No.: 14/249,304

(22) Filed: Apr. 9, 2014

Related U.S. Application Data
(60) Provisional application No. 61/810,022, filed on Apr. 9, 2013.

(51) Int. Cl. A01B 1/04; E21B 11/00; A01B 1/22

(52) U.S. Cl. CPC A01B 1/04; A01B 1/22; E21B 11/005
USPC 294/50.7; 294/59; 294/57; 294/49

(57) ABSTRACT

A shovel device for digging in ground or other material is provided. The shovel device comprises a handle having a first end and a second end. A blade having an attachment end and a digging edge opposite the attachment end is provided with the attachment end secured to the second end of the handle. A plurality of teeth is secured to the digging edge of the blade and extending beyond the digging edge of the blade. During digging operations, the teeth contact the ground or other material prior to the digging edge of the blade contacting the ground or other material.

### CLAIM OF PRIORITY

This patent application claims priority under 35 USC 119 (e) (1) from U.S. Provisional Patent Application Ser. No. 61/810,022, filed on Apr. 9, 2013, invented by Dan Stefanik entitled, “Ultimate Shovel.”

### BACKGROUND OF THE INVENTION

1. Field of the Invention

This invention relates generally to a shovel device and, more particularly, the invention relates to a shovel device which equips the blade of a standard round- or square-point digging shovel with five teeth or tines penetrating and breaking the ground with a pick-like action as the blade of the shovel is forced downward into the surface.

2. Description of the Prior Art

Whether round-point spade or square-point shovel, these traditional hand-tools depend on a cutting blade to break and penetrate the ground being dug. However, conventional shovels lack efficiency and improvements are needed to make its use all the more effective and easy for the user or worker. Manually operated shovels for digging in and moving earth and snow are widely used. In the past, shovels generally included a broad blade and a handle extending from the blade. Some shovel blades included a substantially flat blade portion that terminated in squared edge, others included a slightly curved blade portion that tapered from a wide section to a triangular point. Additional shovels have included blades with either a rounded edge or even a serrated edge. In all of the aforementioned styles, the blade portion is formed of a uniform gauge of material, usually steel, that is cut and bent into a desired shape thereby forming the blade portion of the shovel. A handle is then attached to the blade.

The problem with the aforementioned shovels is that the blade portion of the shovel is difficult to push into material. Despite having a thin edge, the overall surface area of the blade drags significantly on the material regardless of whether the blade terminates in a squared edge, rounded edge, tapered or triangular edge or even a serrated edge. In each instance the thickness of the edge is substantially the same as the thickness of the blade. Thus when the edge penetrates a plane of a material, the surface area of the blade comes into contact with the material. As the shovel blade progresses into the material, an increasing amount of blade surface comes into contact with the material creating friction, making it increasingly harder for an operator to penetrate the material. Additionally, because the shovel blades are of substantially uniform thickness, a suction may be created between the blade and the material making it difficult for the operator to both continue to penetrate the material and extract the blade from the material.

### SUMMARY

The present invention is a shovel device for digging in ground or other material. The shovel device comprises a handle having a first end and a second end. A blade having an attachment end and a digging edge opposite the attachment end is provided with the attachment end secured to the second end of the handle. A plurality of teeth is secured to the digging edge of the blade and extending beyond the digging edge of the blade. During digging operations, the teeth contact the ground or other material prior to the digging edge of the blade contacting the ground or other material.

In addition, the present invention includes a shovel device for digging in ground or other material. The shovel device comprises a handle having a first end and a second end. A blade having an attachment end and a digging edge opposite the attachment end is provided with the attachment end secured to the second end of the handle. A plurality of parallel teeth is secured to the digging edge of the blade and extend beyond the digging edge of the blade. The plurality of teeth is evenly spaced along the digging edge of the blade and equally spaced from each other. The teeth are aligned with the handle such that the teeth and the handle are substantially parallel to each other. During digging operations, the teeth contact the ground or other material prior to the digging edge of the blade contacting the ground or other material.

The present invention further includes a method for digging in ground or other material. The method comprises providing a handle having a first end and a second end, providing a blade having an attachment end and a digging edge opposite the attachment end, securing the attachment end to the second end of the handle, securing a plurality of parallel teeth to the digging edge of the blade, evenly spacing the teeth along the digging edge of the blade, equally spacing the teeth from each other, extending the teeth beyond the digging edge of the blade, aligning the teeth with the handle such that the teeth and the handle are substantially parallel to each other, and contacting the teeth with the ground or other material prior to the digging edge of the blade contacting the ground or other material.

### BRIEF DESCRIPTION OF THE DRAWINGS

FIG. 1 is a perspective view illustrating a shovel device, constructed in accordance with the present invention;

FIG. 2 is another perspective view illustrating the shovel device of FIG. 1, constructed in accordance with the present invention;

FIG. 3 is perspective view illustrating another embodiment of the shovel device, constructed in accordance with the present invention;

FIG. 4 is another perspective view illustrating the shovel device of FIG. 3, constructed in accordance with the present invention; and

FIG. 5 is a perspective view illustrating still another embodiment of the shovel device, constructed in accordance with the present invention.

### DETAILED DESCRIPTION OF THE PREFERRED EMBODIMENTS

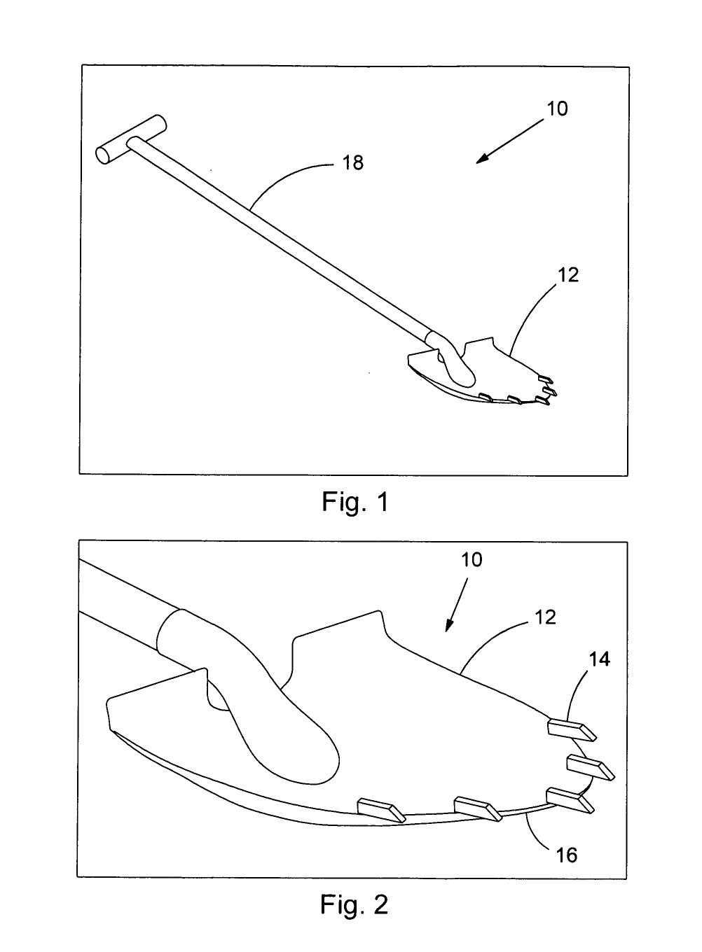

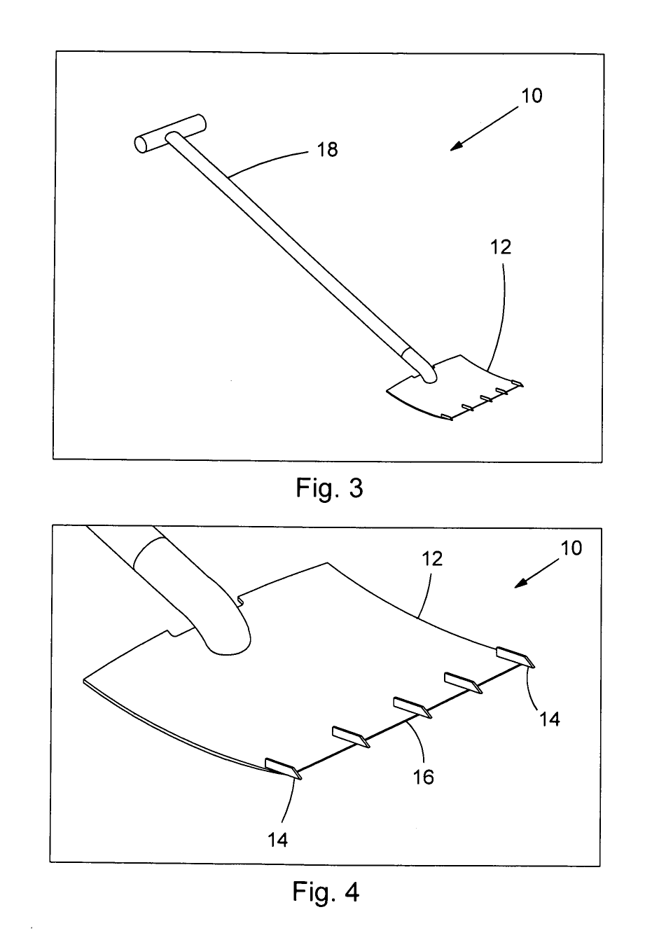

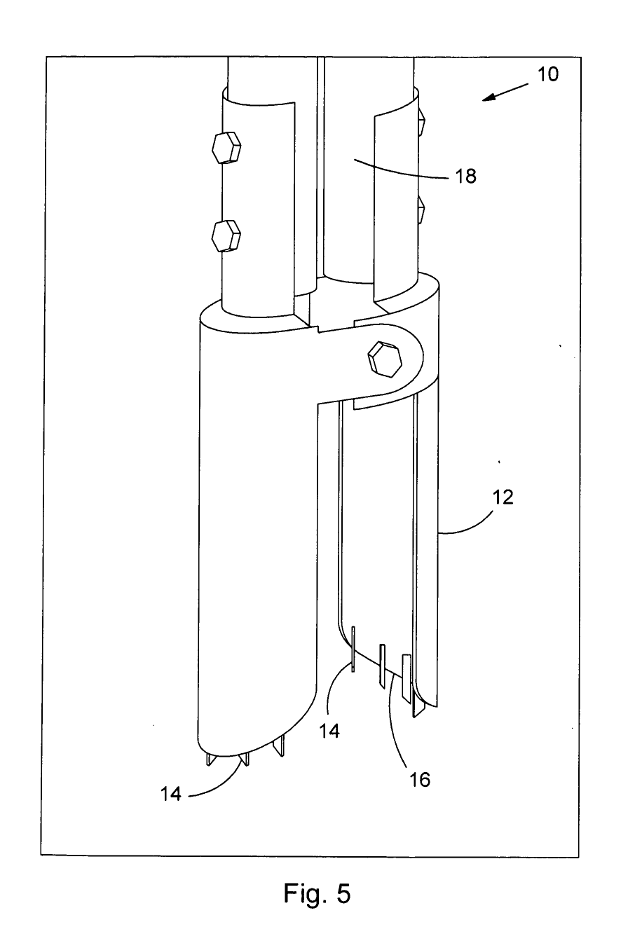

As illustrated in FIGS. 1-5, the present invention is a shovel device, indicated generally at 10, which equips a standard round- or square-point digging shovel blade 12 with a plurality of teeth or tines 14 penetrating and breaking the ground with a pick-like action as the blade 12 of the shovel device 10 is forced downward into the surface. Preferably, the shovel device 10 has five (5) teeth or tines 14 extending from a digging edge 16 of the blade 12 although it is within the scope of the present invention for the shovel device 10 to have more than five (5) teeth or tines 14 or less than five (5) teeth or tines extending from the blade 14.

Preferably, the blade 12 of the shovel device 10 of the present invention is constructed from a heavy-gauge, tempered steel material, extended steel sockets to maximize handle strength and prying leverage; and a handle 18 (providable in a variety of lengths) of a strong, light wood such as ash or other wood material. With the shovel device 10, the digging edge 16 of the blade 12 has a plurality of teeth 14 secured to the digging edge 16 of the blade 12 such as by welding or formed in the blade 12 during the manufacturing process in a production model. The teeth 14 are preferably solid cylindrical steel, one-half (1/2″) inch in diameter, pointed, and extend one-quarter (¼″) inch downward from the digging edge 16 of the blade 12 of the shovel device 10, with five teeth 14, preferably, arrayed in a regularly spaced series along the digging or cutting edge of the blade(s). The teeth 14 are preferably one and one-quarter (1 ¼″) inches in length with one (¼″) (1″) inch of the length welded to the shovel blade 12 and one-quarter (¼″) inch extending beyond the digging edge 16 of the blade 12. The shovel device 10 lends itself to the improvement of any type of digging shovel, which indicates that the greatest potential for the shovel device 10 is as a product line of special-purpose shovels, as opposed to a single shovel product.

In a preferred embodiment, the teeth 14 of the shovel device 10 are evenly spaced along the digging edge 16 of the blade 12 and equally spaced from each other. Also, it is preferably that the teeth 14 are parallel to each other such that during digging operations, the teeth 14 all enter the ground at the same angle thereby increasing the digging effectiveness. Finally, it is preferred that the teeth 14 are aligned with the handle 18 such that the teeth 14 and the handle 14 are substantially parallel to each other. This further increases the digging efficiency by allowing the teeth 14 to enter the ground or other digging surface aligned with the handle 14 providing maximum breaking of the ground or other digging surface.

The toothed design of the shovel device 10 of the present invention makes the shovel device 10 the ultimate digging tool. The teeth 14 of the shovel device 10 act as a miniature pick-ax for the blade 12 of the shovel device 10, penetrating the ground and breaking the ground surface to prepare the surface for the entry of the entire blade 12. No other shovel is so equipped; and the incorporation of the steel teeth 14 into the blade 12 of the shovel device 10 dramatically improves the effectiveness and efficiency of the tool. In fact, the benefits of the shovel device 10 can be incorporated on a post hole digger or any other type of digging tool to make digging easier and more efficient.

In addition, the shovel device 10 of the present invention makes digging easier than with a conventional shovel by facilitating the breaking of the ground for anyone who uses the shovel device 10. Constructed of premium quality materials and designed for a long working life, the shovel device 10 clearly rises above conventional shovels.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A shovel device for digging in ground or other material, the shovel device comprising:
a handle having a first end and a second end;
a blade having an attachment end and a digging edge opposite the attachment end, the attachment end secured to the second end of the handle; and
a plurality of teeth secured to the digging edge of the blade and extending beyond the digging edge of the blade;
wherein during digging operations, the teeth contact the ground or other material prior to the digging edge of the blade contacting the ground or other material.

2. The shovel device of claim 1 wherein the second end of the handle is releasably secured to the attachment end of the blade.

3. The shovel device of claim 1 wherein the plurality of teeth are evenly spaced along the digging edge of the blade and equally spaced from each other.

4. The shovel device of claim 1 wherein each of the teeth are parallel to each other.

5. The shovel device of claim 4 wherein the teeth are aligned with the handle such that the teeth and the handle are substantially parallel to each other.

6. The shovel device of claim 1 and further comprising:
five (5) teeth.

7. The shovel device of claim 1 wherein the teeth are welded to the digging edge of the blade.

8. The shovel device of claim 1 wherein the teeth are integral to the digging edge of the blade, formed on the digging edge of the blade during manufacture of the shovel device.

9. The shovel device of claim 1 wherein the blade is a round- or square-point digging blade.

10. The shovel device of claim 1 wherein the blade is a post hole digging blade.

11. A shovel device for digging in ground or other material, the shovel device comprising:
a handle having a first end and a second end;
a blade having an attachment end and a digging edge opposite the attachment end, the attachment end secured to the second end of the handle; and
a plurality of parallel teeth secured to the digging edge of the blade and extending beyond the digging edge of the blade, the plurality of teeth being evenly spaced along the digging edge of the blade and equally spaced from each other;
wherein the teeth are aligned with the handle such that the teeth and the handle are substantially parallel to each other; and
wherein during digging operations, the teeth contact the ground or other material prior to the digging edge of the blade contacting the ground or other material.

12. The shovel device of claim 11 wherein the second end of the handle is releasably secured to the attachment end of the blade.

13. The shovel device of claim 11 and further comprising:
five (5) teeth.

14. The shovel device of claim 11 wherein the teeth are welded to the digging edge of the blade.

15. The shovel device of claim 11 wherein the teeth are integral to the digging edge of the blade, formed on the digging edge of the blade during manufacture of the shovel device.

16. The shovel device of claim 11 wherein the blade is a round- or square-point digging blade.

17. The shovel device of claim 11 wherein the blade is a post hole digging blade.

18. A method for digging in ground or other material, the method comprising:
providing a handle having a first end and a second end;
providing a blade having an attachment end and a digging edge opposite the attachment end;
securing the attachment end to the second end of the handle;
securing a plurality of parallel teeth to the digging edge of the blade;
evenly spacing the teeth along the digging edge of the blade;
equally spacing the teeth from each other;
extending the teeth beyond the digging edge of the blade;
aligning the teeth with the handle such that the teeth and the handle are substantially parallel to each other; and
contacting the teeth with the ground or other material prior to the digging edge of the blade contacting the ground or other material.

19. The method of claim 18 wherein the blade is a round- or square-point digging blade.

20. The method of claim 18 wherein the blade is a post hole digging blade.
